(19) United States
(12) Patent Application Publication
(10) Pub. No.: US 2014/0208714 A1
(43) Pub. Date: Jul. 31, 2014

(54) Thermal Management for Gas Turbine Engine

(71) Applicant: United Technologies Corporation, (US)

(72) Inventors: Anthony C. Jones, San Diego, CA (US); Charles Brian Travelbee, San Diego, CA (US); Patrick M. Lydon, San Marcos, CA (US); Eric J. Alexander, San Diego, CA (US); Nagamany Thayalakhandan, San Diego, CA (US)

(73) Assignee: UNITED TECHNOLOGIES CORPORATION, Connecticut, CT (US)

(21) Appl. No.: 13/719,706

(22) Filed: Dec. 19, 2012

(51) Int. Cl. F02K 3/02; F42B 15/10; B64C 39/02

(52) U.S. Cl. CPC F02K 3/02; B64C 39/02; F42B 15/10
USPC 60/226.1; 415/108; 60/737

(57) ABSTRACT

A gas turbine engine has an inlet duct, which is configured to communicate with an inlet to a compressor. The inlet duct is further configured to communicate air outwardly of an outer casing of the gas turbine engine, and to pass the air along an axial length of the gas turbine engine to cool a component associated with the gas turbine engine.

### BACKGROUND OF THE INVENTION

This application relates to a miniature gas turbine engine, which is used to power an aircraft, such as a drone or ballistic missile.

Miniature gas turbine engines are utilized to power aircraft such as unmanned drones, or ballistic missiles. These gas turbine engines generate very high heat, and travel at a high speed.

An air scoop delivers inlet air directly into a compressor in the miniature gas turbine engine.

Various components on miniature gas turbine engines are subject to undue amounts of heat.

### SUMMARY OF THE INVENTION

In a featured embodiment, a gas turbine engine has an inlet duct, which is configured to communicate with an inlet to a compressor. The inlet duct is further configured to communicate air outwardly of an outer casing of the gas turbine engine, and to pass the air along an axial length of the gas turbine engine to cool a component associated with the gas turbine engine.

In another embodiment according to the previous embodiment, the inlet duct has a manifold that curves radially outwardly at a downstream end to allow the air to flow along the outer casing of the gas turbine engine.

In another embodiment according to any of the previous embodiments, an axial length of the gas turbine engine is less than 15 inches (38.1 centimeters).

In another embodiment according to any of the previous embodiments, the gas turbine engine includes a compressor that compresses air and delivers it into a combustion section where it is mixed with fuel and ignited. The products of the combustion pass downstream over a turbine rotor driving the turbine rotor to rotate. The gases downstream of the turbine rotor pass outwardly of a nozzle to provide propulsion for the vehicle.

In another embodiment according to any of the previous embodiments, the cooling air exits at a downstream end adjacent the nozzle.

In another embodiment according to any of the previous embodiments, the gas turbine engine provides 180 foot pounds of thrust or less.

In another featured embodiment, a vehicle has a body with at least one aerodynamic surface. A gas turbine engine includes an inlet duct configured to communicate with an inlet to a compressor. The inlet duct is further configured to communicate cooling air outwardly of an outer casing of the gas turbine engine, and passes along an axial length of the gas turbine engine to cool a component associated with the gas turbine engine.

In another embodiment according to the previous embodiment, the inlet duct has a manifold that curves radially outwardly at a downstream end to allow the air to flow along the outer casing of the gas turbine engine.

In another embodiment according to any of the previous embodiments, an outer casing for the vehicle is spaced radially away from the outer casing of the gas turbine engine. The cooling airflow passes between an inner surface of the vehicle outer casing and the outer casing of the gas turbine engine.

In another embodiment according to any of the previous embodiments, the vehicle is an unmanned drone.

In another embodiment according to any of the previous embodiments, the vehicle carries a ballistic missile.

In another embodiment according to any of the previous embodiments, the compressor compresses air and delivers it into a combustion section where it is mixed with fuel and ignited. Products of the combustion pass downstream over a turbine rotor, and drive the turbine rotor to rotate. The gases downstream of the turbine rotor pass outwardly of a nozzle to provide propulsion for the vehicle.

In another embodiment according to any of the previous embodiments, the cooling air exits adjacent the nozzle.

In another embodiment according to any of the previous embodiments, the gas turbine engine provides 180 foot pounds of thrust or less.

In another embodiment according to any of the previous embodiments, an axial length of the gas turbine engine is less than 15 inches (38.1 centimeters).

In another embodiment according to any of the previous embodiments, the component includes at least one of an actuator or an electronic control.

These and other features may be best understood from the following drawings and specification.

### BRIEF DESCRIPTION OF THE DRAWINGS

FIG. 1 schematically shows an aircraft including a miniature gas turbine engine.

FIG. 2 shows airflow across the miniature gas turbine engine.

### DETAILED DESCRIPTION

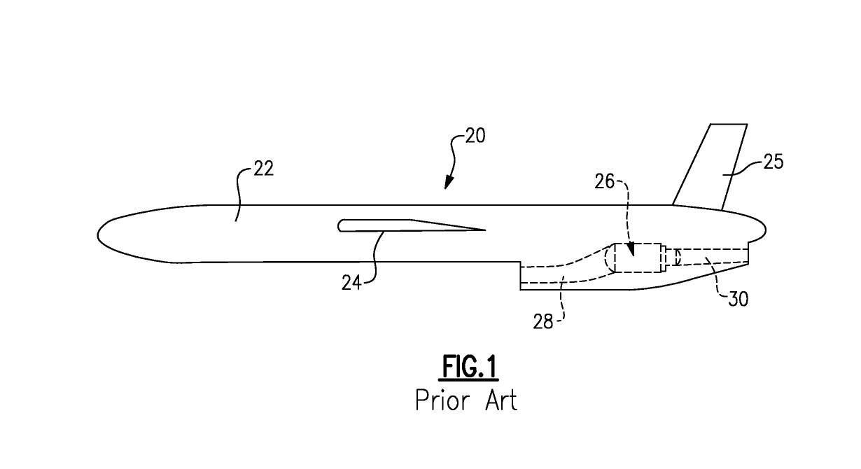

FIG. 1 shows miniature gas turbine engine 26 associated with a vehicle 20. Vehicle 20 includes a main body 22, and aerodynamic surfaces 24 and 25. The vehicle 20 may be utilized as an aircraft drone, or may be utilized as a ballistic missile. Other applications may come within the scope of this application.

An air inlet duct 28 supplies air into the gas turbine engine 26. The gas turbine engine operates to compress the air, mix the air with fuel, combust it, and pass products of that combustion across at least one turbine rotor. The turbine rotor is driven to rotate to drive a compressor. The products of the combustion pass outwardly of a nozzle 30 downstream of the turbine section, and provide propulsion for the vehicle 20.

The term “miniature gas turbine engine” may generally relate to gas turbine engines which have an axial length of less than 15 inches (38.1 centimeters), and which provide 180 foot pounds of thrust or less.

In FIG. 1, the inlet duct 28 delivers airflow into an inlet for a compressor in the miniature gas turbine engine 26.

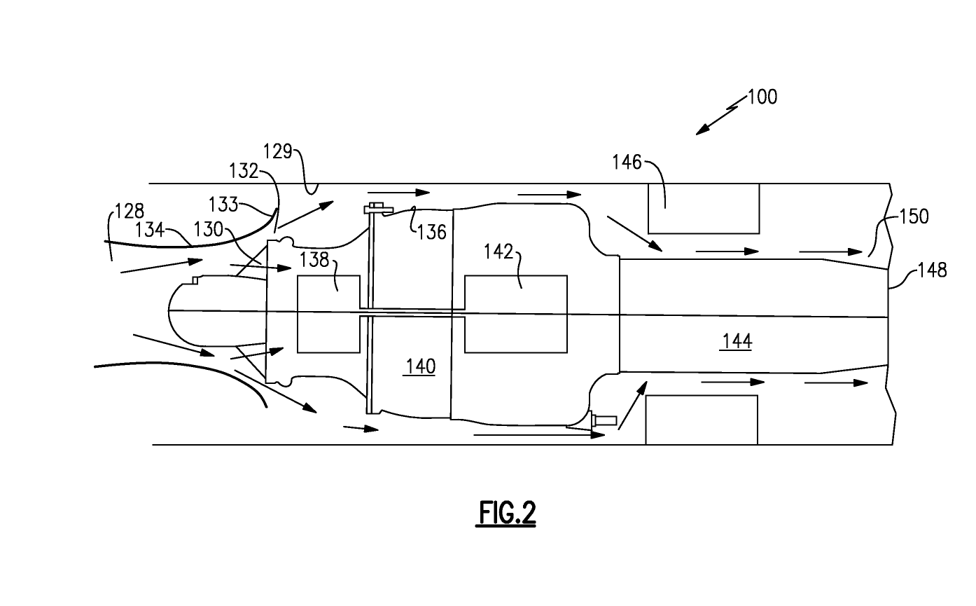

FIG. 2 shows an embodiment of a miniature gas turbine engine 100. In miniature gas turbine engine 100, an inlet 128 delivers air into a core inlet 130 delivering the air into a compressor rotor 138. That air is compressed in the compressor rotor 138, mixed with fuel and ignited in a combustion section 140 and products of that combustion pass over at least one turbine rotor 142. The turbine rotor 142 drives a compressor rotor 138.

An outlet nozzle 148 delivers the products of the combustion downstream of the turbine rotor outwardly to provide thrust for a vehicle such as vehicle 20.

An inlet duct 134 curves outwardly at a downstream end 133, and delivers cooling air 132 into a gap between an outer casing 136 of the gas turbine engine, and an inner surface of a casing 129 of the vehicle 20 of FIG. 1. This airflow passes downstream outwardly at the nozzle end 150. This airflow passes over one or more components 146 to cool those components. The components 146 may be actuators, electronic controls, or any other item which needs to be cooled.

By utilizing a portion of the air entering the inlet 128, the gas turbine engine 100 simply provides cooling to the components.

While this disclosure focuses on miniature gas turbine engines, it may have benefits in larger gas turbine engines (e.g., engines delivering more than 180 foot pounds of thrust, and longer than 15 inches).

Although an embodiment of this invention has been disclosed, a worker of ordinary skill in this art would recognize that certain modifications would come within the scope of this invention. For that reason, the following claims should be studied to determine the true scope and content of this invention.

1. A gas turbine engine comprising:
an inlet duct, said inlet duct configured to communicate with an inlet to a compressor;
said inlet duct further configured to communicate air outwardly of an outer casing of the gas turbine engine, and to pass the air along an axial length of the gas turbine engine to cool a component associated with said gas turbine engine.

2. The gas turbine engine as set forth in claim 1, wherein said inlet duct has a manifold that curves radially outwardly at a downstream end to allow the air to flow along the outer casing of the gas turbine engine.

3. The gas turbine engine as set forth in claim 1, wherein an axial length of the gas turbine engine is less than 15 inches (38.1 centimeters).

4. The gas turbine engine as set forth in claim 1, wherein said gas turbine engine includes a compressor compressing air and delivering it into a combustion section where it is mixed with fuel and ignited, the products of the combustion passing downstream over a turbine rotor driving the turbine rotor to rotate, the gases downstream of the turbine rotor passing outwardly of a nozzle to provide propulsion for the vehicle.

5. The gas turbine engine as set forth in claim 4, wherein the cooling air exits at a downstream end adjacent the nozzle.

6. The gas turbine engine as set forth in claim 1, wherein said gas turbine engine provides 180 foot pounds of thrust or less.

7. A vehicle comprising:
a body having at least one aerodynamic surface; and
a gas turbine engine, the gas turbine engine including an inlet duct, said inlet duct configured to communicate with an inlet to a compressor;
said inlet duct further configured to communicate cooling air outwardly of an outer casing of the gas turbine engine, and for passing along an axial length of the gas turbine engine to cool a component associated with said gas turbine engine.

8. The vehicle as set forth in claim 7, wherein said inlet duct has a manifold that curves radially outwardly at a downstream end to allow the air to flow along the outer casing of the gas turbine engine.

9. The vehicle as set forth in claim 7, wherein an outer casing for the vehicle is spaced radially away from the outer casing of the gas turbine engine, and the cooling airflow passes between an inner surface of the vehicle outer casing and the outer casing of the gas turbine engine.

10. The vehicle as set forth in claim 7, wherein said vehicle is an unmanned drone.

11. The vehicle as set forth in claim 7, wherein the vehicle carries a ballistic missile.

12. The vehicle as set forth in claim 7, wherein said compressor compressing air and delivering it into a combustion section where it is mixed with fuel and ignited, and products of the combustion passing downstream over a turbine rotor, driving the turbine rotor to rotate, and the gases downstream of the turbine rotor passing outwardly of a nozzle to provide propulsion for the vehicle.

13. The vehicle as set forth in claim 12, wherein the cooling air exits adjacent the nozzle.

14. The vehicle as set forth in claim 7, wherein said gas turbine engine provides 180 foot pounds of thrust or less.

15. The vehicle as set forth in claim 7, wherein an axial length of the gas turbine engine is less than 15 inches (38.1 centimeters).

16. The vehicle as set forth in claim 7, wherein said component includes at least one of an actuator or an electronic control.
